(19) United States
(12) Patent Application Publication
(10) Pub. No.: US 2011/0184080 A1
(43) Pub. Date: Jul. 28, 2011

(54) HYDROPHILIC, ALIPHATIC POLYURETHANE FOAMS

(75) Inventors: Jan Schönberger, Haan (DE); Burkhard Köhler, Zierenberg (DE); Peter Haas, Haan (DE); Meike Niesten, Köln (DE)

(73) Assignee: Bayer MaterialScience AG, Leverkusen (DE)

(21) Appl. No.: 13/003,205

(22) PCT Filed: Jun. 26, 2009
(86) PCT No.: PCT/EP2009/004610

§ 371 Date: Feb. 17, 2011

(30) Foreign Application Priority Data
Jul. 9, 2008 (EP) 08012372.2

(51) Int. Cl. C08J 9/00

(52) U.S. Cl. 521/90

(57) ABSTRACT

The present invention relates to a process for preparing a hydrophilic aliphatic polyurethane foam which includes providing, curing, and foaming a composition comprising: an isocyanate-functional prepolymer having a weight fraction of low molecular weight aliphatic diisocyanates of below 1.0% by weight based on the prepolymer, obtained by reaction of a low molecular weight aliphatic diisocyanate having a molar mass of 140 to 278 g/mol with a di- to hexafunctional polyalkylene oxide having an OH number of 22.5 to 112 mg KOH/g and an ethylene oxide content of 50 to 100 mol %; optionally a heterocyclic 4-ring or 6-ring oligomer of low molecular weight aliphatic diisocyanates having a molar mass of 140 to 278 g/mol; water; optionally a catalyst; a C₈-C₂₂ monocarboxylic acid or its ammonium or alkali metal salt or a C₁₂-C₄₄ dicarboxylic acid or its ammonium or alkali metal salt; optionally a surfactant; and optionally a mono- or polyhydric alcohol.

The invention relates to hydrophilic aliphatic polyurethane foams which are obtainable by reaction of specific low-monomer prepolymers and optionally oligomeric isocyanates in the presence of water and catalysts. Owing to their absorptive properties, the hydrophilic polyurethane foams are particularly useful in the manufacture of wound dressings, cosmetic articles or incontinence products.

EP-A 949285 describes the reaction of polyisocyanates with primary diamines, low molecular weight polyols and high molecular weight polyols. This reaction does not preclude the possibility that appreciable portions of the isocyanate-reactive substances are not converted and are subsequently extractable from the hydrophilic foam.

GB 1571730 describes the reaction of high vapour pressure diisocyanates such as isophorone diisocyanate (IPDI) and bis(isocyanatocyclohexyl)methane (HMDI) with polyols. Again, unconverted components are left behind. Moreover, using free, non-derivatized diisocyanates is problematic from an occupational hygiene viewpoint. WO 2004013215 likewise utilizes volatile diisocyanates.

GB 1571730 and also U.S. Pat. No. 3,778,390, U.S. Pat. No. 3,799,898 and FR 2077388 recite foam stabilizers comprising silicon-containing and silicon-free nonionic, sulphate, phosphate and sulphonate emulsifiers. These have low cell compatibility, however. The use of carboxylates is not mentioned.

WO 2003/097727, U.S. Pat. No. 5,065,752 and U.S. Pat. No. 5,064,653 describe the foam-forming reaction of prepolymers in the presence of acrylamide-acrylic acid copolymers. These products are not chemically attached and are completely extractable, which is likewise not desirable.

In U.S. Pat. No. 3,903,232 and U.S. Pat. No. 388,941, prepolymers are reacted with polyethers. Again, there is a risk of unattached polyols being produced. U.S. Pat. No. 5,296,518 similarly describes the reaction of prepolymers with polyethers wherein three different polyols are used, which calls the economics of this process into question. Furthermore, the process described therein is incapable of making certain that there are no low molecular weight isocyanates left in the mixture, which would not be desirable. The use of carboxylates is not mentioned. The preparation of the prepolymers usually requires uneconomically long reaction times.

The present invention therefore has for its object to provide a process for preparing hydrophilic aliphatic polyurethane foams which can be used in particular as a constituent of a wound dressing, of a cosmetic article or of an incontinence product and therefore shall contain but little by way of extractables. It is also very important from a process-engineering point of view that the polyurethane foams do not suffer any volume shrinkage after expansion. Furthermore, their preparation shall utilize exclusively polyisocyanates having a low vapour pressure, i.e. no unmodified diisocyanates. The hydrophilic aliphatic polyurethane foams shall moreover provide rapid and high absorption of physiological saline, or of wound fluid, without the need for superabsorbent polymers. Wound dressings comprising these polyurethane foams shall be cell compatible (non-cytotoxic) and shall in use optimally conform to wound shape.

It has now been found that prepolymers formed from aliphatic diisocyanates, preferably HDI, and polyethers having an ethylene oxide content of at least 50 mol % based on the total content of oxyalkylene units are foamable with water in the presence of selected activators and optionally foam stabilizers in mixtures with oligomers based on hexamethylene diisocyanate (HDI) and comprising uretdione groups and isocyanurate groups.

The present invention accordingly provides a process for preparing hydrophilic aliphatic polyurethane foams wherein compositions comprising
A) isocyanate-functional prepolymers having a weight fraction of low molecular weight aliphatic diisocyanates having a molar mass of 140 to 278 g/mol of below 1.0% by weight based on the prepolymer, obtainable by reaction of
   A1) low molecular weight aliphatic diisocyanates having a molar mass of 140 to 278 g/mol with
   A2) di- to hexafunctional, preferably tri- to hexafunctional polyalkylene oxides having an OH number of 22.5 to 112, preferably of 31.5 to 56, and an ethylene oxide content of 50 to 100 mol %, preferably of 60 to 85 mol %, based on the total amount of oxyalkylene groups present,
B) optionally heterocyclic 4-ring or 6-ring oligomers of low molecular weight aliphatic diisocyanates having a molar mass of 140 to 278 g/mol,
C) water,
D) optionally catalysts,
E) C₈-C₂₂ monocarboxylic acids or their ammonium or alkali metal salts or C₁₂-C₄₄ dicarboxylic acids or their ammonium or alkali metal salts,
F) optionally surfactants, and
G) optionally mono- or polyhydric alcohols.
are provided, foamed and cured.

The prepolymers used in A) preferably have a residual monomer content of below 0.5% by weight based on the prepolymer. This content can be achieved through appropriately selected use quantities of A1) and A2). However, it is preferable to use isocyanate A1) in excess and subsequent, preferably distillative, removal of unconverted monomers.

The isocyanate-functional prepolymers of component A) are typically prepared by reacting one equivalent of polyol component A2) with one to 20 mol, preferably one to 10 mol and more preferably 5 to 10 mol of the low molecular aliphatic diisocyanate A1).

The reaction can take place in the presence of urethanization catalysts such as tin compounds, zinc compounds, amines, guanidines or amidines, or in the presence of allophanatization catalysts such as zinc compounds.

The reaction temperature is typically in the range from 25 to 140° C., preferably in the range from 60 to 100° C.

When excess isocyanate was used, the excess of low molecular weight aliphatic diisocyanate is subsequently preferably removed by thin film distillation.

Before, during and after the reaction or distillative removal of the excess diisocyanate, acidic or alkylating stabilizers, such as benzoyl chloride, isophthaloyl chloride, methyl tosylate, chloropropionic acid, HCl or antioxidants, such as di-tert-butylcresol or tocopherol can be added.

The NCO content of the isocyanate-functional prepolymers A) is preferably in the range from 1.5% to 4.5% by weight, more preferably in the range from 1.5% to 3.5% by weight and most preferably in the range from 1.5% to 3.0% by weight.

Examples of low molecular weight aliphatic diisocyanates of component A1) are hexamethylene diisocyanate (HDI), isophorone diisocyanate (IPDI), butylene diisocyanate (BDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate, tetramethylxylylene diisocyanate, norbornane diisocyanate, cyclohexane diisocyanate or diisocyanatododecane, of which hexamethylene diisocyanate (HDI), isophorone diisocyanate (IPDI), butylene diisocyanate (BDI) and bis(isocyanatocyclohexyl)methane (HMDI) are preferred. BDI, HDI, IPDI are particularly preferred and hexamethylene diisocyanate and isophorone diisocyanate are very particularly preferred.

Polyalkylene oxides of component A2) are preferably copolymers of ethylene oxide and propylene oxide having an ethylene oxide content, based on the total amount of oxyalkylene groups present, of 50 to 100 mol %, preferably 60 to 85 mol %, and started on polyols or amines. Suitable starters of this kind are glycerol, trimethylolpropane (TMP), sorbitol, pentaerythritol, triethanolamine, ammonia or ethylenediamine.

The number average molecular weight of the polyalkylene oxides of component A2) is typically in the range from 1000 to 15 000 g/mol and preferably in the range from 3000 to 8500 g/mol.

The polyalkylene oxides of component A2) further have OH functionalities of 2 to 6, preferably of 3 to 6 and more preferably of 3 to 4.

Optional compounds of component B) are heterocyclic 4-ring or 6-ring oligomers of low molecular weight aliphatic diisocyanates having a molar mass of 140 to 278 g/mol such as isocyanurates, iminooxadiazinediones or uretdiones of the aforementioned low molecular weight aliphatic diisocyanates. Heterocyclic 4-ring oligomers such as uretdiones are preferred.

The increased isocyanate group content due to the use of component B) provides better foaming due to more CO₂ formed in the isocyanate-water reaction.

The water used as component C) can be used as such, as water of crystallization of a salt, as solution in a dipolar aprotic solvent or else as an emulsion. Preferably, the water is used as such or in a dipolar aprotic solvent. It is very particularly preferred to use water as such.

To speed urethane formation, component D) may utilize catalysts. The catalysts in question are typically compounds with which a person skilled in the art is familiar from polyurethane technology. Preference here is given to compounds from the group consisting of catalytically active metals, amines, amidines and guanidines. Specific examples are dibutyltin dilaurate (DBTL), tin octanoate (SO), tin acetate, zinc octanoate (ZO), 1,8-diazabicyclo[5.4.0]undecene-7 (DBU), 1,5-diazabicyclo[4.3.0]nonene-5 (DBN), 1,4-diazabicyclo[3.3.0]octene-4 (DBO), N-ethylmorpholine (NEM), triethylenediamine (DABCO), pentamethylguanidine (PMG), tetramethylguanidine (TMG), cyclotetramethylguanidine (TMGC), n-decyltetramethylguanidine (TMGD), n-dodecyltetramethylguanidine (TMGDO), dimethylaminoethyltetramethylguanidine (TMGN), 1,1,4,4,5,5-hexamethylisobiguanidine (HMIB), phenyltetramethylguanidine (TMGP) and hexamethyleneoctamethylbiguanidine (HOBG).

Particular preference is given to the use of amines, amidines, guanidines or mixtures thereof as catalysts of component D). Very particular preference is given to using 1,8-diaza-bicyclo[5.4.0]undecene-7 (DBU).

A preferred embodiment of the invention comprises using compounds of the aforementioned kind as catalysts in component D).

Component E) utilizes ammonium and alkali metal salts of C₈-C₂₂ monocarboxylates or their free carboxylic acids or C₁₂-C₄₄ dicarboxylates or their free dicarboxylic acids, preferably potassium or sodium salts of C₈-C₂₂ monocarboxylates or C₁₂-C₄₄ dicarboxylates and more preferably sodium salts of C₈-C₂₂ monocarboxylates.

Examples of compounds useful as component E) are the ammonium, sodium, lithium or potassium salts of ethylhexanoic acid, octanoic acid, decanoic acid, dodecanoic acid, palmitic acid, stearic acid, the octadecenoic acids, the octadecadienoic acids, the octadecatrienoic acids, isostearic acid, erucic acid, abietic acid and hydrogenation products thereof. Examples of C₁₂-C₄₄ dicarboxylic acids and the ammonium and alkali metal salts derived therefrom are dodecanedioic acid, dodecenylsuccinic acid, tetradecenylsuccinic acid, hexadecenylsuccinic acid, octadecenylsuccinic acid, C₃₆ and C₄₄ dimer fatty acids and hydrogenation products thereof and also the corresponding ammonium, sodium, lithium or potassium salts of these dicarboxylic acids.

Compounds of component F) can be used to improve foam formation, foam stability or the properties of the resulting polyurethane foam, in which case such additives can in principle be any known anionic, cationic, amphoteric and nonionic surfactants and also mixtures thereof. Preference is given to using alkylpolyglycosides, EO-PO block copolymers, alkyl or aryl alkoxylates, siloxane alkoxylates, esters of sulphosuccinic acid and/or alkali or alkaline earth metal alkanoates. Particular preference is given to using EO-PO block copolymers. Preferably, the EO-PO block copolymers are solely used as component F).

In addition, compounds of component G) can be used to improve the foam properties of the resulting polyurethane foam. These compounds comprise in principle any mono- and polyhydric alcohols known per se to a person skilled in the art, and also mixtures thereof.

These are mono- or polyhydric alcohols or polyols, such as ethanol, propanol, butanol, decanol, tridecanol, hexadecanol, ethylene glycol, neopentyl glycol, butanediol, hexanediol, decanediol, trimethylolpropane, glycerol, pentaerythritol, monofunctional polyether alcohols and polyester alcohols, polyether diols and polyester diols.

Components A) to G) are typically used in the following amounts:
A) 100 parts by weight of isocyanate-functional prepolymers A)
B) 0 to 30 parts by weight of heterocyclic oligomers B)
C) 0.1 to 200 parts by weight of water
D) 0 to 1 part by weight of catalysts
E) 0.01 to 5 parts by weight of C₈-C₁₂ monocarboxylic acids or their ammonium or alkali metal salts or C₁₂-C₄₄ dicarboxylic acids or their ammonium or alkali metal salts
F) 0 to 10 parts by weight of surfactants F)
G) 0 to 20 parts by weight of alcohols G)

Components A) to G) are preferably used in the following amounts:
A) 100 parts by weight of isocyanate-functional prepolymers A)
B) 1 to 30 parts by weight of heterocyclic oligomers B)
C) 0.1 to 100 parts by weight of water
D) 0.01 to 1 part by weight of catalysts
E) 0.01 to 5 parts by weight of C₈-C₁₂ monocarboxylic acids or their ammonium or alkali metal salts or C₁₂-C₄₄ dicarboxylic acids or their ammonium or alkali metal salts
F) 0 to 5 parts by weight of surfactants
G) 0 to 10 parts by weight of alcohols G)

Components A) to G) are more preferably used in the following amounts:
A) 100 parts by weight of isocyanate-functional prepolymers A)
B) 5 to 15 parts by weight of heterocyclic oligomers B)
C) 1 to 60 parts by weight of water
D) 0.1 to 0.5 part by weight of catalysts
E) 0.1 to 1 part by weight of C₈-C₁₂ monocarboxylic acids or their ammonium or alkali metal salts or C₁₂-C₄₄ dicarboxylic acids or their ammonium or alkali metal salts

The hydrophilic aliphatic polyurethane foams according to the invention are prepared by mixing the components A), C), E) and optionally B), D), F), G) in any order, foaming the mixture and curing preferably by chemical crosslinking. The components A) and B) are preferably premixed with each other. The carboxylates E) and, if used, the surfactants F) are added to the reaction mixture in the form of aqueous solutions.

Foaming can in principle be effected by means of the carbon dioxide formed in the course of the reaction of the isocyanate groups with water, but the use of further blowing agents is likewise possible. It is thus also possible in principle to use blowing agents from the class of the hydrocarbons such as C₃-C₆ alkanes, for example butanes, n-pentane, isopentane, cyclopentane, hexanes or the like, or halogenated hydrocarbons such as dichloromethane, dichloromono-fluoromethane, chlorodifluoroethanes, 1,1-dichloro-2,2,2-trifluoroethane, 2,2-dichloro-2-fluoro-ethane, particularly chlorine-free hydrofluoro carbons such as difluoromethane, trifluoromethane, difluoroethane, 1,1,1,2-tetrafluoroethane, tetrafluoroethane (R 134 or R 134a), 1,1,1,3,3-penta-fluoropropane (R 245 fa), 1,1,1,3,3,3-hexafluoropropane (R 256), 1,1,1,3,3-pentafluorobutane (R 365 mfc), heptafluoropropane, or else sulphur hexafluoride. Mixtures of these blowing agents can also be used.

Subsequent curing typically takes place at room temperature.

The present invention further provides the compositions according to the invention and also hydrophilic aliphatic polyurethane foams obtainable therefrom.

The present invention further provides the polyurethane foams prepared by the process of the present invention and also for the use of the hydrophilic aliphatic polyurethane foams as flexible foams, as constituent of a wound dressing, of a cosmetic article or of an incontinence product. However, the use of the polyurethane foams as constituent of a wound dressing, of a cosmetic article or of an incontinence product is preferable, the use as a constituent of a wound dressing is more preferable and the use as a wound dressing with direct skin and wound contact on the human or animal skin is very particularly preferred.

The polyurethane foams have a porous, at least partially open-cell structure having intercommunicating cells. The density of the polyurethane foams is typically in the range from 0.01 to 0.5 g/cm³, preferably in the range from 0.02 to 0.4 g/cm³, more preferably in the range from 0.05 to 0.3 g/cm³ and most preferably in the range from 0.1 to 0.2 g/cm³ (determined according to DIN 53420).

The physiological saline absorbence of the polyurethane foams is typically in the range from 100 to 2000%, preferably in the range from 300 to 2000%, more preferably in the range from 800 to 2000% and most preferably in the range from 1000 to 1800% (mass of imbibed liquid based on mass of dry foam; determined according to DIN EN 13726-1 Part 3.2). Compared with other hydrophilic foams, the polyurethane foams according to the invention provide a very high physiological saline absorbence even without the use of superabsorbent polymers. However, the incorporation of superabsorbents is also possible with the polyurethane foams according to the invention, as will be appreciated.

The polyurethane foams have good mechanical strength and high elasticity. Tensile strength is typically greater than 40 kPa, breaking extension greater than 30% and rebound elasticity greater than 60%. Preferably, tensile strength is greater than 50 kPa, breaking extension greater than 40% and rebound elasticity greater than 80% (determined according to DIN 53504, DIN 53455, DIN EN ISO 3386-1).

After they have been prepared, the polyurethane foams can be made into sheetlike materials in a conventional manner and then be used, for example, as a constituent of a wound dressing, of a cosmetic article or of an incontinence product. Generally, to this end, slab foams are cut to the desired thickness by common methods to obtain sheetlike materials having a thickness of typically 10 μm to 5 cm, preferably 0.1 mm to 1 cm, more preferably 0.1 mm to 6 mm and most preferably 0.2 mm to 6 mm.

However, the sheetlike materials described can also be obtained directly by suitable casting techniques, by application and foaming of the composition according to the invention onto a substrate, for example an optionally pretreated paper or textile.

The polyurethane foams contain a but minimal water-extractable fraction of not more than 2% by weight and preferably not more than 1% by weight; i.e., they contain only very small amounts of constituents which are not chemically bound.

The polyurethane foams may be adhered to or laminated or coated with further materials, for example materials based on hydrogels, (semi)permeable films, foam films, coatings, hydrocolloids or other foams.

The polyurethane foams according to the invention are particularly useful in the manufacture of wound dressings. In these dressings, the polyurethane foams can be in direct or indirect contact with the wound. Preferably, however, the polyurethane foams are used in direct contact with the wound in order that optimum absorbence of wound fluid may be ensured for example. The polyurethane foams exhibit no cytotoxicity (determined according to ISO 10993-5 and ISO 10993-12).

The polyurethane foams which are used as wound dressing have to be additionally sterilized in a further operation. The sterilization is effected using processes known per se to one skilled in the art, wherein sterilization is effected by thermal treatment, chemical substances such as ethylene oxide or irradiation for example by gamma irradiation. Irradiation here may be carried out under protective gas atmosphere, where appropriate. The polyurethane foams according to the invention have the immense advantage of not discolouring on irradiation, in particular on irradiation with gamma rays.

It is likewise possible to add, incorporate or coat antimicrobially or biologically active components which have a positive effect for example in relation to wound healing and the avoidance of germ loads.

### EXAMPLES

Unless stated otherwise, all percentages are by weight. Solids contents were determined according to DIN-EN ISO 3251. Viscosities were determined at 23° C. to DIN 53019. NCO contents were determined volumetrically in accordance with DIN-EN ISO 11909.

### Substances and Abbreviations Used:

Carboxylate 1: 10% of sodium oleate in water
Carboxylate 2: 10% of sodium 2-ethylhexanoate in water
Dispergiermittel EM: polyether polyol dispersant of OH number 70 mg KOH/g (Rhein Chemie Rheinau GmbH, Mannheim, Germany)
Zusatzmittel VP.PU 3240: polyglycol ester addition of OH number 100 mg KOH/g (Rhein Chemie Rheinau GmbH, Mannheim, Germany)
Tegostab® B 2370: polysiloxane-polyoxyalkylene block copolymer (Degussa-Goldschmidt AG, Essen, Germany)
Desmodur® N 3400: aliphatic polyisocyanate (HDI uretdione), NCO content 21.8%
Desmodur® N 3600: aliphatic polyisocyanate (HDI isocyanurate), NCO content 24%
Pluronic® PE 3500: EO/PO block copolymer (BASF, Ludwigshafen, Germany)
Pluronic® PE 6800: EO/PO block copolymer (BASF, Ludwigshafen, Germany)
Desmophen® 41WBO1: polyether polyol of OH number 37 mg KOH/g (Bayer Material-Science AG, Leverkusen, Germany)
Polyether PW 56: polyether polyol of OH number 56 mg KOH/g (Bayer Material-Science AG, Leverkusen, Germany)
Polyether PEG 400: polyether polyol of OH number 280 mg KOH/g (BASF AG, Ludwigshafen, Germany)
Polyether LB 25: monofunctional polyether based on ethylene oxide-propylene oxide, number average molecular weight 2250 g/mol, OH number 25 mg KOH/g (Bayer MaterialScience AG, Leverkusen, Germany)

### Example 1

### Preparation of Polyurethane Prepolymer 1

A mixture of 1000 g HDI and 1 g of benzoyl chloride was admixed at 80° C. during 3 h with 1000 g of a polyalkylene oxide having a molar mass of 4680 g/mol started on glycerol, an ethylene oxide weight fraction of 72% and a propylene oxide weight fraction of 28% and dried beforehand at 100° C. during 6 h at a pressure of 0.1 mbar, by dropwise addition and subsequently stirred for 12 h. Excess REM was removed by thin film distillation at 130° C. and 0.1 mbar, and the non-volatile constituents were stabilized with 1 g of chloropropionic acid. This gave a prepolymer having an NCO content of 2.77% and a viscosity of 3500 mPas.

### Example 2

### Preparation of Polyurethane Prepolymer 2

A mixture of 200 g HDI, 1 g of benzoyl chloride and 1 g of methyl tosylate was admixed at 80° C. during 2 h with 400 g of a polyalkylene oxide having a molar mass of 5800 g/mol started on glycerol, an ethylene oxide content of 80% and a propylene oxide content of 20% and dried beforehand at 100° C. during 6 h at a pressure of 0.1 mbar, by dropwise addition and subsequently stirred for 12 h. Excess HDI was removed by thin film distillation at 130° C. and 0.1 mbar. This gave a prepolymer having an NCO content of 2.31% and a viscosity of 6070 mPas.

### Example 3

### Preparation of Polyurethane Prepolymer 3

A mixture of 1440 g HDI and 4 g of benzoyl chloride was admixed at 80° C. during 2 h with 2880 g of a polyalkylene oxide having a molar mass of 4680 g/mol started on glycerol, an ethylene oxide weight fraction of 72% and a propylene oxide weight fraction of 28% and dried beforehand at 100° C. during 6 h at a pressure of 0.1 mbar, by dropwise addition and subsequently stirred for 1 h. Excess HDI was removed by thin film distillation at 130° C. and 0.1 mbar. This gave a prepolymer having an NCO content of 2.11% and a viscosity of 3780 mPas.

### Example 4

### Preparation of Polyurethane Prepolymer 4

A mixture of 200 g IPDI, 1 g of benzoyl chloride and 1 g of methyl tosylate was admixed at 80° C. during 2 h with 400 g of a polyalkylene oxide having a molar mass of 5800 g/mol started on glycerol, an ethylene oxide content of 80% and a propylene oxide content of 20% and dried beforehand at 100° C. during 6 h at a pressure of 0.1 mbar, by dropwise addition and subsequently stirred for 12 h. Excess IPDI was removed by thin film distillation at 130° C. and 0.1 mbar. This gave a prepolymer having an NCO content of 2.36% and a viscosity of 8800 mPas.

### Examples 5-13

### Preparation of Foamed Materials from Polyurethane Prepolymers 1-3

The two isocyanate components were homogenized for 15 seconds at a stirrer speed of 1200 rpm, at which point the other components were weighed in, followed by stirring for a further 10 seconds, and transfer to a 500 ml capacity beaker.

| | Example | | | | | | | | |
|---|---|---|---|---|---|---|---|---|---|
| Component [g] | 5 | 6 | 7 | 8 | 9 | 10 | 11 | 12 | 13 |
| Prepolymer | 36.0¹⁾ | 36.0²⁾ | 36.0²⁾ | 36.0²⁾ | 36.0²⁾ | 20.0²⁾ | 20.0³⁾ | 20.0²⁾ | 20.0²⁾ |
| Oligomer | 4.0⁴⁾ | 4.0⁴⁾ | 4.0⁴⁾ | 4.0⁴⁾ | 4.0⁴⁾ | 2.2⁵⁾ | 2.2⁴⁾ | | 2.2⁴⁾ |
| Additive | 0.6⁶⁾ | 0.6⁶⁾ | 1.2⁷⁾ | | 0.6⁸⁾ | | 0.4⁹⁾ | 0.4⁹⁾ | 0.4⁹⁾ |
| DBU | 0.05 | 0.05 | 0.05 | 0.05 | 0.05 | 0.03¹⁰⁾ | 0.03 | 0.03¹⁰⁾ | 0.03¹⁰⁾ |
| Carboxylate | 2.0¹¹⁾ | 2.0¹²⁾ | 2.0¹¹⁾ | 2.0¹¹⁾ | 2.0¹¹⁾ | 1.1¹¹⁾ | 1.1¹¹⁾ | 1.1¹¹⁾ | 1.1¹¹⁾ |
| Starting time [s] | 7 | 35 | 30 | 15 | 26 | 28 | 20 | 30 | 20 |
| Raw density | 0.12 | 0.12 | 0.12 | 0.12 | 0.13 | 0.14 | 0.17 | 0.27 | 0.13 |
| [g/cm³] | | | | | | | | | |

¹⁾Prepolymer 2;
²⁾Prepolymer 1;
³⁾Prepolymer 3;
⁴⁾Desmodur N 3400;
⁵⁾Desmodur N 3600;
⁶⁾Dispergiermittel EM;
⁷⁾Zusatzmittel VP.PU 3240/Tegostab ® B 2370 (each 50%);
⁸⁾Pluronic ® PE 3500;
⁹⁾Pluronic ® PE 6800;
¹⁰⁾dissolved in 0.5 g of Desmophen ® 41WB01;
¹¹⁾Carboxylate 1;
¹²⁾Carboxylate 2

Examples 5 to 13 gave foamed materials of evenly fine cellular structure, which are dimensionally stable and elastic. After loading, they exhibit very high resilience and a low compression set with a relatively low compression hardness of 1-5 kPa at 40% compression at higher raw densities. This is important for a good imbibition capacity with regard to wound exudate and conformation to contours. An exemplary test was carried out in accordance with the ISO 10993.5 guideline to show that the foam resulting from Example 13 must be classed as non-cytotoxic.

As Example 12 shows, more compact polyurethane foams are obtained on omitting the heterocyclic oligomers B).

### Comparative Example 1

### Carboxylate-Free Reaction of Prepolymers

Under comparable conditions to Examples 5-13, 20.0 g of prepolymer 1 and 2.2 g of Desmodur N 3400 were initially homogenized and then admixed with a solution of 0.03 g of DBU in 1.0 g of water. Foam expansion began after a starting time of 20 seconds, but the resulting foam suffered considerable shrinkage. Even the addition of conventional foam auxiliaries such as for example Pluronic® PE 6800 to the aqueous solution of the catalyst does not prevent this shrinkage.

As this comparative example illustrates, the carboxylates according to the invention constitute a crucial component in the foam production described. Without these salts, the expanded polyurethane foams shrink—notwithstanding the addition of well-known foam additives—severely, which is technically not preferable. Similarly, severe shrinkage is observed for the resulting polyurethane foams when corresponding alkali metal sulphates or phosphates are used.

### Examples 14-17

### Preparation of Foamed Materials from Polyurethane Prepolymer 1

20.0 g of prepolymer 1 and 2.2 g of Desmodur® N 3400 were homogenized at a stirrer speed of 1200 rpm for 15 seconds, at which point 0.03 g of DBU dissolved in 0.5 g of Desmophen® 41WB01, 1.1 g of carboxylate 1 and 0.2 g of the alcohol component were weighed in, followed by a further 10 seconds of stirring and transfer to a 250 ml capacity beaker.

| | Example | | | |
|---|---|---|---|---|
| | 14 | 15 | 16 | 17 |
| Alcohol | 1,4- | Polyether | Polyether | Polyether |
| | Butanediol | PEG 400 | PW 56 | LB 25 |
| Starting time [s] | 20 | 21 | 20 | 30 |
| Raw density [g/cm³] | 0.13 | 0.13 | 0.12 | 0.16 |

As Examples 14 to 17 illustrate, foamed materials of generally fine cellular structure, which are dimensionally stable and elastic, were obtained even after the aqueous carboxylates according to the invention were blended with diols.

### Examples 18-24

### Preparation of Foamed Materials from Polyurethane Prepolymer 1

20.0 g of prepolymer 1 and 2.2 g of Desmodur® N 3400 were homogenized at a stirrer speed of 1200 rpm for 15 seconds, at which point 0.03 g of catalyst and 1.1 g of carboxylate 1 were weighed in, followed by a further 10 seconds of stirring and transfer to a 250 ml capacity beaker.

| | Example | | | | | | |
|---|---|---|---|---|---|---|---|
| | 18 | 19 | 20 | 21 | 22 | 23 | 24¹⁾ |
| Catalyst | DBU | DABCO | SO | ZO | TMG | — | — |
| Starting | 20 | 40 | 30 | 60 | 40 | 50 | 120 |
| time [s] | | | | | | | |
| Raw | 0.13 | 0.11 | 0.13 | 0.13 | 0.16 | 0.13 | 0.11 |
| density | | | | | | | |
| [g/cm³] | | | | | | | |
| Cellular | fine | fine | fine | very | fine | medium | fine |
| structure | | | | coarse | | | |

¹⁾Carboxylate 1 replaced by 1.0 g of a 2% strength aqueous sodium oleate solution

As Examples 18 to 22 illustrate, the cellular structure was influenced by the choice of catalyst as well as the reaction rate. Examples 23 and 24 also illustrate that carboxylate 1 also has catalytic properties.

### Example 25

### Preparation of a Foamed Material from Polyurethane Prepolymer 4

To determine DIN 53577 compression hardness and DIN 53420 raw density, 108 g of prepolymer 4 and 12 g of Desmodur N 3400 were homogenized for 15 seconds at a stirrer speed of 1200 rpm in a 1000 ml polypropylene vessel. Then, 1.8 g of Dispergiermittel EM, 0.15 g of DBU and 3 g of carboxylate 1 were added and the mixture was stirred for a further 10 seconds. The resulting cured foam did not exhibit major adherence to the vessel walls. It had a compression hardness of 3.1 kPa at 40% compression and also a raw density of 0.08 g/cm³.

### Example 26

### Determination of the Extractables of Polyurethane Foam 5

10 g of the foam from Example 5 were placed for 48 hours in 300 ml of completely ion-free water at 36° C. and the chemical oxygen demand was titrated in accordance with DIN EN 1484 to determine the amount of extractables. It was found to be 0.6% by weight.

### Example 27

### Determination of the Extractables of Polyurethane Foam 8

4.7 g of the foam from Example 8 were placed for 7 days in 220 ml of completely ion-free water at 37° C. and the chemical oxygen demand was titrated in accordance with DIN EN 1484 to determine the amount of extractables. It was found to be 0.2% by weight.

Example 24 of U.S. Pat. No. 5,065,752, the sole example in which at least a portion of the isocyanate was aliphatic, describes a foam having an extractables content of 30% by weight.

### Examples 28 to 30

### Formulation with Excess Water

Examples 29 and 30 show versus Example 28 (no extra water) that incorporating excess quantities of water in the formulation lengthens the processing time (casting time) to obtain extremely finely celled homogeneous foams. Dilution with water gives thinner, but very homogeneous foams which are particularly suitable for wound dressings.

| Components [g] | 28 | 29 | 30 |
|---|---|---|---|
| Prepolymer | 20.0¹⁾ | 20.0¹⁾ | 20.0¹⁾ |
| Oligomer | 2.2²⁾ | 2.2²⁾ | 2.2²⁾ |
| DBU | 0.027 | 0.027 | 0.027 |
| Carboxylate | 1.1³⁾ | 1.1³⁾ | 1.1³⁾ |
| Water | 0 | 4 | 10 |
| Starting time [s] | 25 | 40 | 60 |
| Casting time [s] | 35 | 50 | 70 |
| Raw density | 0.17 | 0.26 | 0.40 |
| [g/cm³] | | | |
| Foam thickness | 15 | 8 | 4 |
| after casting (mm) | | | |
| Pore quality | Fine but not homo- | Very fine | Very fine |
| | geneous, locally | and homo- | and homo- |
| | coarse pores | geneous | geneous |

¹⁾prepolymer 2
²⁾Desmodur N 3400;
³⁾carboxylate 1, 10% solution in water

1.-12. (canceled)

13. A process for preparing a hydrophilic aliphatic polyurethane foam which comprises providing, curing, and foaming a composition comprising:
A) an isocyanate-functional prepolymer having a weight fraction of low molecular weight aliphatic diisocyanates having a molar mass of 140 to 278 g/mol of below 1.0% by weight based on the prepolymer, obtained by reaction of
A1) a low molecular weight aliphatic diisocyanate having a molar mass of 140 to 278 g/mol with
A2) a di- to hexafunctional polyalkylene oxide having an OH number of 22.5 to 112 mg KOH/g and an ethylene oxide content of 50 to 100 mol % based on the total amount of oxyalkylene groups,
B) optionally a heterocyclic 4-ring or 6-ring oligomer of low molecular weight aliphatic diisocyanates having a molar mass of 140 to 278 g/mol,
C) water,
D) optionally a catalyst,
E) a C₈-C₂₂ monocarboxylic acid or its ammonium or alkali metal salt or a C₁₂-C₄₄ dicarboxylic acid or its ammonium or alkali metal salt,
F) optionally a surfactant, and
G) optionally a mono- or polyhydric alcohol.

14. The process according to claim 13, wherein the NCO content of the isocyanate-functional prepolymers is 1.5% to 3.0% by weight.

15. The process according to claim 13, wherein the low molecular weight aliphatic diisocyanate is selected from the group consisting of a hexamethylene diisocyanate (HDI), an isophorone diisocyanate (IPDI), and mixtures thereof.

16. The process according to claim 13, wherein the di- to hexafunctional polyalkylene oxide comprises copolymers of ethylene oxide and propylene oxide having an ethylene oxide content, based on the total amount of oxyalkylene groups present, of 60 to 85 mol % and started on polyols or amines.

17. The process according to claim 13, wherein the di- to hexafunctional polyalkylene oxide has a number average molecular weight of 3000 to 8500 g/mol.

18. The process according to claim 13, wherein the di- to hexafunctional polyalkylene oxide has OH functionalities of 3 to 4.

19. The process according to claim 13, wherein the heterocyclic 4-ring or 6-ring oligomer is present and is a heterocyclic 4-ring oligomer.

20. The process according to claim 13, wherein the catalyst is selected from the group consisting of metal salts, amines, amidines, guanidines, and mixtures thereof.

21. The process according to claim 13, wherein components A) to E) are present in the following amounts:
A) 100 parts by weight of the isocyanate-functional prepolymer;
B) 5 to 15 parts by weight of the heterocyclic oligomer;
C) 1 to 200 parts by weight of the water;
D) 0.1 to 0.5 parts by weight of the catalyst; and
E) 0.1 to 1 part by weight of the C₈-C₁₂ monocarboxylic acids or their ammonium or alkali metal salts or the C₁₂-C₄₄ dicarboxylic acids or their ammonium or alkali metal salts.

22. A composition comprising:
A) an isocyanate-functional prepolymer having a weight fraction of low molecular weight aliphatic diisocyanates having a molar mass of 140 to 278 g/mol of below 1.0% by weight based on the prepolymer, obtained by reaction of
A1) a low molecular weight aliphatic diisocyanate having a molar mass of 140 to 278 g/mol with
A2) a di- to hexafunctional polyalkylene oxide having an OH number of 22.5 to 112 mg KOH/g and an ethylene oxide content of 50 to 100 mol % based on the total amount of oxyalkylene groups,
B) optionally a heterocyclic 4-ring or 6-ring oligomer of low molecular weight aliphatic diisocyanates having a molar mass of 140 to 278 g/mol,
C) water,
D) optionally a catalyst,
E) a C₈-C₂₂ monocarboxylic acid or its ammonium or alkali metal salt or a C₁₂-C₄₄ dicarboxylic acid or its ammonium or alkali metal salt,
F) optionally a surfactant, and
G) optionally a mono- or polyhydric alcohol.

23. A polyurethane foam obtainable according to the process of claim 13.

24. A polyurethane foam obtainable according to the process of claim 22.

25. A wound dressing, a cosmetic article or an incontinence product comprising the polyurethane foam according to claim 23.

26. A wound dressing, a cosmetic article or an incontinence product comprising the polyurethane foam according to claim 24.

27. The composition according to claim 22, wherein the di- to hexafunctional polyalkylene oxide is a tri- to hexafunctional polyalkylene oxide.

28. The composition according to claim 22, wherein the OH number of the di- to hexafunctional polyaklyene oxide has an OH number of 31.5 to 56.

29. The composition according to claim 22, wherein the ethylene oxide content of the di- to hexafunctional polyalkylene oxide is from 60 to 85 mol %, based on the total amount of oxyalkylene groups present.

30. The composition according to claim 27, wherein the OH number of the di- to hexafunctional polyaklyene oxide has an OH number of 31.5 to 56 and wherein the ethylene oxide content of the di- to hexafunctional polyalkylene oxide is from 60 to 85 mol %, based on the total amount of oxyalkylene groups present.
